(19) United States
(12) Patent Application Publication
(10) Pub. No.: US 2008/0109217 A1
(43) Pub. Date: May 8, 2008

(54) Method, Apparatus and Computer Program Product for Controlling Voicing in Processed Speech

(75) Inventor: Jani K. Nurminen, Lempaala (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/557,691

(22) Filed: Nov. 8, 2006

(51) Int. Cl. G10L 11/06

(52) U.S. Cl. 704/208; 704/E11.007

(57) ABSTRACT

An apparatus for providing control of voicing in processed speech includes a spectra approximation element and a comparing element. The spectra approximation element may be configured to compute a voiced contribution and an unvoiced contribution for each of a reference speech sample and a processed speech sample. The comparing element may be configured to compare indications of voiced and unvoiced contributions of the reference speech sample and indications of voiced and unvoiced contributions of the processed speech sample, and to determine whether to correct at least one of the voiced or unvoiced contributions of the processed speech sample based on the comparison.

### TECHNOLOGICAL FIELD

Embodiments of the present invention relate generally to speech coding and processing technology and, more particularly, relate to a method, apparatus, and computer program product for providing control of voicing in processed or coded speech.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

In many applications, it is necessary for the user to receive audio information such as oral feedback or instructions from the network. An example of such an application may be paying a bill, ordering a program, receiving driving instructions, etc. Furthermore, in some services, such as audio books, for example, the application is based almost entirely on receiving audio information. It is becoming more common for such audio information to be provided by computer generated voices. Accordingly, the user's experience in using such applications will largely depend on the quality and naturalness of the computer generated voice. As a result, much research and development has gone into improving the quality and naturalness of computer generated voices.

One specific application of such computer generated voices that is of interest is known as text-to-speech (TTS). TTS is the creation of audible speech from computer readable text. Other specific applications may include speech coding, speech conversion, feature transformation or any other type of processed speech. However, it is common for many speech processing techniques to either intentionally or unintentionally introduce changes into the spectra of the processed speech. These changes in spectra may also cause unwanted changes in the voicing of the output speech that result in speech quality degradation. In this regard, voicing levels in speech include voiced contributions (contributions due to vibration of the vocal chords) and unvoiced contributions (contributions produced without vibration of the vocal cords). Changes in voicing may be perceived as unnatural speech.

Accordingly, it may be desirable to introduce a mechanism by which the voicing of processed speech may be controlled in order to overcome the deficiencies described above.

### BRIEF SUMMARY

A method, apparatus and computer program product are therefore provided that provide for controlling voicing in processed speech. For example, a sample of processed speech may be compared to a sample of original or reference speech to determine whether the effects of spectra changes caused by speech processing are significant enough to cause voicing changes above a threshold. Accordingly, if voicing changes are perceived above the threshold, actions may be taken to correct voicing levels in an effort to achieve a more natural sounding processed speech output.

In one exemplary embodiment, a method of controlling voicing in processed speech is provided. The method includes computing a voiced contribution and an unvoiced contribution for each of a reference speech sample and a processed speech sample, comparing indications of voiced and unvoiced contributions of the reference speech sample and indications of voiced and unvoiced contributions of the processed speech sample, and determining whether to correct at least one of the voiced or unvoiced contributions of the processed speech sample based on the comparison.

In another exemplary embodiment, a computer program product for controlling voicing in processed speech is provided. The computer program product includes at least one computer-readable storage medium having computer-readable program code portions stored therein. The computer-readable program code portions include first, second and third executable portions. The first executable portion is for computing a voiced contribution and an unvoiced contribution for each of a reference speech sample and a processed speech sample. The second executable portion is for comparing indications of voiced and unvoiced contributions of the reference speech sample and indications of voiced and unvoiced contributions of the processed speech sample. The third executable portion is for determining whether to correct at least one of the voiced or unvoiced contributions of the processed speech sample based on the comparison.

In another exemplary embodiment, an apparatus for controlling voicing in processed speech is provided. The apparatus includes a spectra approximation element and a comparing element. The spectra approximation element may be configured to compute a voiced contribution and an unvoiced contribution for each of a reference speech sample and a processed speech sample. The comparing element may be configured to compare indications of voiced and unvoiced contributions of the reference speech sample and indications of voiced and unvoiced contributions of the processed speech sample, and to determine whether to correct at least one of the voiced or unvoiced contributions of the processed speech sample based on the comparison.

In another exemplary embodiment, an apparatus for controlling voicing in processed speech is provided. The apparatus includes means for computing a voiced contribution and an unvoiced contribution for each of a reference speech sample and a processed speech sample, means for comparing indications of voiced and unvoiced contributions of the reference speech sample and indications of voiced and unvoiced contributions of the processed speech sample, and means for determining whether to correct at least one of the voiced or unvoiced contributions of the processed speech sample based on the comparison.

Embodiments of the invention may provide a method, apparatus and computer program product for employment in speech processing devices. As a result, for example, mobile terminals and other electronic devices may benefit from more natural sounding processed speech.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of portions of an apparatus for providing control of voicing in processed speech according to an exemplary embodiment of the present invention;

FIG. 4 illustrates experimental data showing an exemplary situation where controlling voicing in processed speech may be utilized according to an exemplary embodiment of the present invention; and

FIG. 5 is a block diagram according to an exemplary method for providing control of voicing in processed speech according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

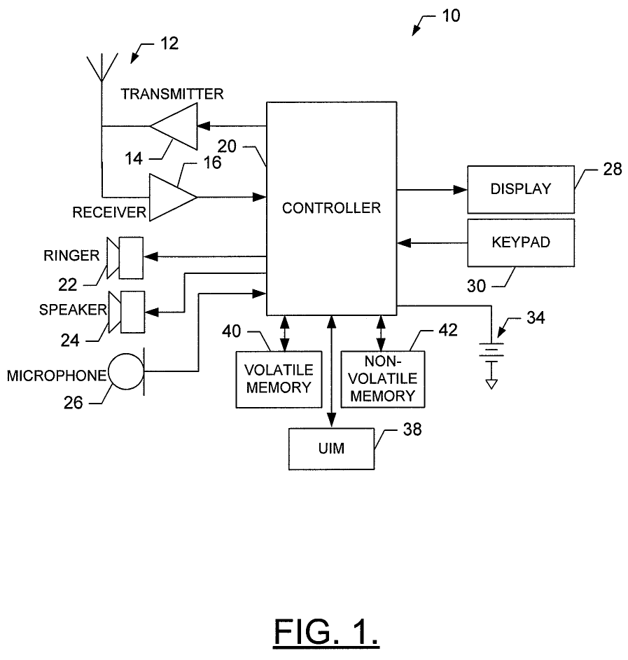

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, and TD-SCDMA.

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a universal identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

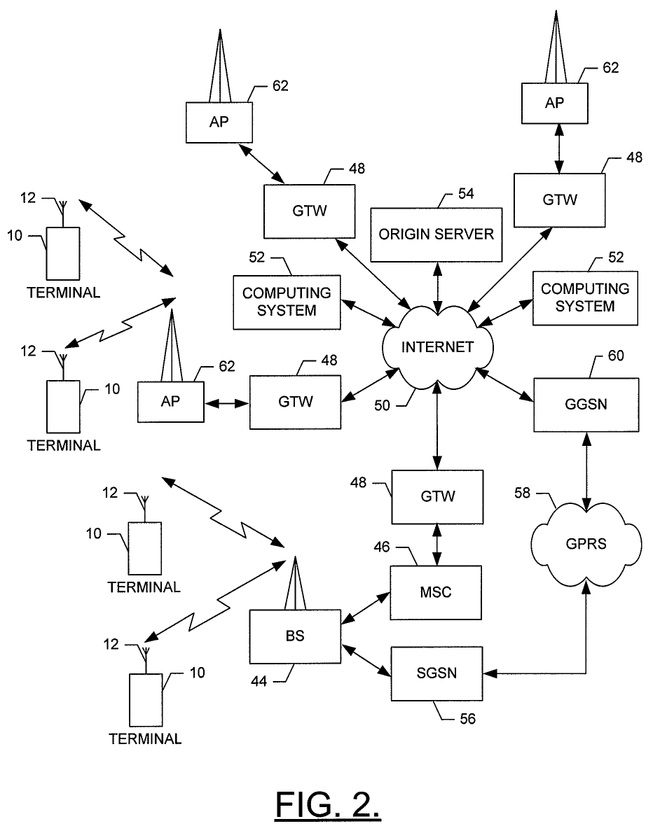

Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

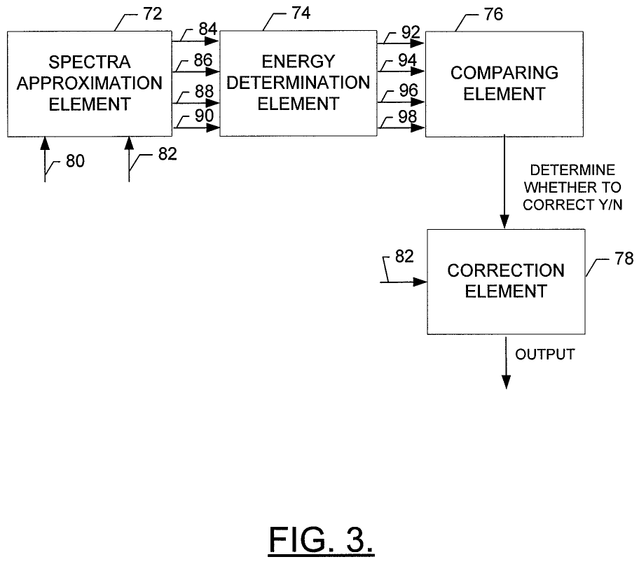

An exemplary embodiment of the invention will now be described with reference to FIG. 3, in which certain elements of a system for controlling voicing in processed speech are displayed. The system of FIG. 3 may be employed, for example, on the mobile terminal 10 of FIG. 1. However, it should be noted that the system of FIG. 3, may also be employed on a variety of other devices, both mobile and fixed, and therefore, embodiments of the present invention should not be limited to application on devices such as the mobile terminal 10 of FIG. 1. It should also be noted, however, that while FIG. 3 illustrates one example of a configuration of a system for controlling voicing in processed speech, numerous other configurations may also be used to implement embodiments of the present invention. Furthermore, although FIG. 3 will be described in the context of speech conversion to illustrate an exemplary embodiment, the present invention need not necessarily be practiced in the context of speech conversion, but instead applies more generally to any processed speech. Thus, embodiments of the present invention may also be practiced in other exemplary applications such as, for example, in the context of voice or sound generation in gaming devices, voice conversion in chatting or other applications in which it is desirable to hide the identity of the speaker, translation applications, TTS, speech coding, etc.

Referring now to FIG. 3, an apparatus for providing control of voicing in processed speech is provided. The apparatus includes a spectra approximation element 72, an energy determination element 74, a comparing element 76 and a correction element 78. In an exemplary embodiment, each of the spectra approximation element 72, the energy determination element 74, the comparing element 76 and the correction element 78 may operate under the control of a processing element such as, for example, the controller 20 of FIG. 1. Each of the spectra approximation element 72, the energy determination element 74, the comparing element 76 and the correction element 78 may be any device or means embodied in either hardware, software, or a combination of hardware and software capable of performing the respective functions associated with each of the corresponding elements as described in greater detail below. However, in general terms, the preceding elements may include the corresponding functions that follow. The spectra approximation element 72 may be configured to determine approximations of voiced and unvoiced contributions in an overall spectrum of a speech sample. The energy determination element 74 may be configured to compute a relevant energy of the sample based on the overall spectrum. The comparing element 76 may be configured to compare indications of energy values and/or compare results of functions performed with respect to computed energy values and determine whether or not results of such comparisons exceed a particular threshold. Finally, the correction element 78 may be configured to modify processed speech to achieve voicing level corrections based upon the output of the comparing element 76.

In an exemplary embodiment, the spectra approximation element 72, the energy determination element 74, the comparing element 76 and the correction element 78 may be embodied in software as instructions that are stored on a memory of the mobile terminal 10 and executed by the controller 20. It should be noted that although FIG. 3 illustrates the spectra approximation element 72, the energy determination element 74, the comparing element 76 and the correction element 78 all as being separate elements, two or more of such elements may also be collocated or embodied in a single module, element or device capable of performing the corresponding functions of each of the elements.

As shown in FIG. 3, the spectra approximation element 72 may be configured to receive inputs including a reference speech sample 80 and a corresponding processed speech sample 82 either of which may have been received, or may subsequently be transmitted, for example, via the system of FIG. 2. The reference and processed speech samples 80 and 82 may each be a respective frame of speech or a collection of a plurality of speech frames. In an exemplary embodiment in the context of speech conversion, the reference speech sample 80 may be a frame of original speech as provided by a speaker whose speech is to be converted by any speech conversion process known in the art. Meanwhile, the processed speech sample 82 may be a frame of converted or processed speech which corresponds to original speech which underwent a speech conversion or speech processing, respectively. It should be noted that, as stated above, although the apparatus of FIG. 3 will now be described in the context of speech conversion, the apparatus may alternatively be employed in the context of any device or system which utilizes processed speech. Thus, for example, in the context of a text-to-speech application (TTS), the reference speech sample 80 may be a concatenated collection of clips of pre-stored speech and the processed speech sample 82 may be a corresponding processed sample in which boundary areas (e.g., areas at which one sound clip meets an adjacent sound clip) between the concatenated clips have been processed. However, it should be understood that if an embodiment of the present invention is applied to correcting the voicing in a particular sentence, spectrum estimation and other processing may be accomplished on a frame-by-frame basis and, depending on sentence length, the sentence may include many frames (e.g., 300).

In response to receipt of the reference and processed speech samples 80 and 82, the spectra approximation element 72 may be configured to determine approximations of the voiced and unvoiced contributions in each of the reference and processed speech samples 80 and 82. However, the spectra approximation element 72 may include an initial inspection of the reference and processed speech samples 80 and 82 to ensure that the corresponding frames have non-zero values. If the reference and processed speech samples 80 and 82 have zero values, further processing of the corresponding frames may be forgone in order to reduce processing or computation requirements by directing that processing should not be performed during silent periods. As will be appreciated by those skilled in the art, many methods of determining such approximations exist and are dependent upon the speech model being utilized. Accordingly, it should be understood that the spectra approximation element 72 may be configured to perform any suitable approximation corresponding to the speech model being utilized in any given application. In an exemplary embodiment, spectra approximations may be performed by forming residual amplitude spectra for each of the voiced and unvoiced contributions and multiplying values sampled at harmonic frequencies by corresponding magnitude responses of linear prediction filters derived from line spectral frequencies. Depending on the speech model, each harmonic frequency may be approximated to have only a voiced or unvoiced contribution. Alternatively, both voiced and unvoiced contributions can co-exist at each harmonic frequency. In either of the cases above, the frequency-dependent voicing levels can be estimated based on the signal periodicity. The approximations of the voiced and unvoiced contributions in each of the reference and processed speech samples 80 and 82 (e.g., reference voiced contribution 84, reference unvoiced contribution 86, processed voiced contribution 88, and processed unvoiced contribution 90) may then be communicated to the energy determination element 74.

As stated above, the energy determination element 74 may be configured to compute the corresponding energy of the samples based on the overall spectrum. In this regard, any method known in the art for computing energy of spectra may be employed in embodiments of the present invention. The energy of the voiced and unvoiced contributions in each of the reference and processed speech samples 80 and 82 (e.g., E_{(ref, voiced)} 92, E_{(ref, unvoiced)} 94, E_{(proc, voiced)} 96, E_{(proc, unvoiced)} 98) may then be communicated to the comparing element 76.

As stated above, the comparing element 76 may be configured to compare indications of energy values and/or compare results of functions performed with respect to computed energy values and determine whether or not results of such comparisons exceed a particular threshold. For example, the comparing element 76 may be configured to perform a function on values of the energy of the voiced and unvoiced contributions in each of the reference and processed speech samples 80 and 82 (e.g., E_{(ref, voiced)} 92, E_{(ref, unvoiced)} 94, E_{(proc, voiced)} 96, E_{(proc, unvoiced)} 98). In an exemplary embodiment, the comparing element 76 may be configured to compute a reference speech voicing ratio [E_{(ref, voiced)}/(E_{(ref, voiced)}+E_{(ref, unvoiced)})] and a processed speech voicing ratio [E_{(proc, voiced)}/(E_{(proc, voiced)}+E_{(proc, unvoiced)})]. In other words, the reference speech voicing ratio may be a ratio of one of the voiced or unvoiced reference speech contributions to a sum of the voiced and unvoiced reference speech contributions and the processed speech voicing ratio may be a ratio of one of the voiced or unvoiced processed speech contributions to a sum of the voiced and unvoiced processed speech contributions.

A difference between the reference speech voicing ratio and the processed speech voicing ratio may then be compared to a threshold. The threshold may be either a predefined (i.e., fixed value) or a value that is selected by a user which defines an amount of difference between the voicing in processed and reference speech which is considered acceptable. In other words, if the difference between voicing in processed and reference speech is below the threshold, the processed speech may be considered to be of acceptable quality and no voicing correction may be performed. Meanwhile, if the difference between voicing in the processed and reference speech is above the threshold, the processed speech may receive voicing correction as described below. In any case, the threshold may be selected based upon experimentation or arbitrarily. Some factors that may be considered in selection of the threshold may include a quality of the processed speech output (e.g., a listener may sample the output and determine whether the sample sounds natural), or computational limitations. Thus, for example, if processing or computational limitations are negligible, the threshold may be set very low or even to zero. However, if processing or computational limitations are not negligible (e.g., in a device of limited resources such as a mobile telephone), the threshold may be set in consideration of the processing power which is available for use in processing for voicing control in accordance with embodiments of the present invention.

After a determination is made regarding whether the threshold is exceeded with respect to a particular reference speech frame and corresponding processed speech frame, the comparing element 76 may communicate with the correction element 78 or any other device in a speech signal processing chain in order to further process the processed speech sample 82 based on the determination. For example, if the difference between the reference speech sample 80 and the processed speech sample 82 is below the threshold, the correction element 78 may send a signal to the correction element 78 to indicate that no further processing of the processed speech sample 82 is desired and the processed speech sample 82 may be provided as an output for the corresponding frame or frames. Alternatively, if the difference between the reference speech sample 80 and the processed speech sample 82 is above the threshold, the correction element 78 may send a signal to the correction element 78 to indicate that further processing of the processed speech sample 82 is desired and the processed speech sample 82 may receive further processing at the correction element 78.

The correction element 78 may be configured to modify the processed speech sample 82 to achieve voicing level corrections based upon the output of the comparing element 76. In this regard, if the comparing element 76 indicates that the processed speech sample 82 should receive further processing, the correction element 78 is configured to provide modification of the processed speech sample 82 in order to achieve voicing level corrections. In an exemplary embodiment, either or both of the voiced and unvoiced portions of the spectrum of the processed speech sample 82 may be scaled by being multiplied by a modification factor. In a simple exemplary embodiment, a corrected processed speech sample 100 may be produced by multiplying a voiced portion of the residual amplitude spectrum of the processed speech sample 82 (i.e., processed voiced contribution 88) by a modification factor (m). The modification factor (m) may be calculated, for example, using the equation m=[(E_{(ref, voiced)}*E_{(proc, unvoiced)})/(E_{(proc, voiced)}*E_{(ref, unvoiced)})]. As can be seen from the equation above, the modification factor may correct voicing in a processed speech sample to match voicing in a reference speech sample. The scaling may also be frequency dependent, such that different modification factors may be applied to respective different frequency bands. For example, each harmonic may represent a frequency band having a corresponding different modification factor. If the speech is modeled using split-band voicing, the voicing level correction can also be obtained by shifting the splitting frequency.

Thus, in accordance with an exemplary embodiment of the present invention, if a processed speech signal has incorrect or undesirable voicing as determined audibly by a user or based on predefined criteria (e.g., the voicing of the processed speech is different from that of the original speech by at least a threshold amount), which may have been intentionally or unintentionally introduced by the processing mechanism employed to process the reference or original speech, adjustments may be made to reshape the processed speech signal to provide corrected voicing levels as described above. However, in some situations it may be desirable to perform the different steps of the voicing correction scheme using some alternative representation of speech. In the case of parametric modeling, an embodiment of the present invention and/or an application that uses an embodiment of the present invention can, in some situations, utilize different parametric representations. As such, a determination may be made as to whether to convert back to an original parametric representation after correcting the voicing or to produce the output speech directly using the alternative representation used by embodiments of the present invention. In this regard, various parametric representations are available for speech representation such as multiband modeling, waveform interpolation, or other modeling techniques that may separate speech into vocal track and excitation components. In some situations in which scaling must be done in a particular parametric representation, conversion to the original parametric representation may be performed after producing a corrected parameter set in the particular parametric representation.

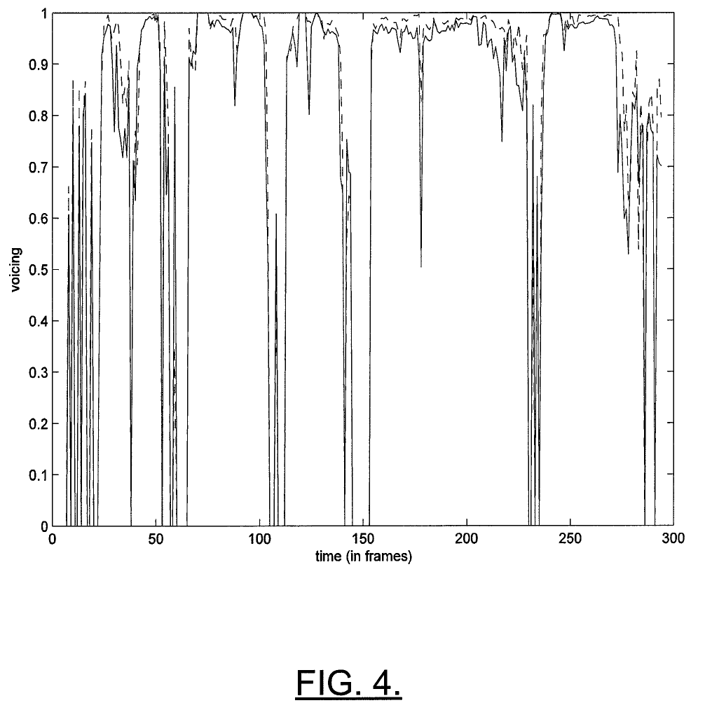

FIG. 4 shows experimental results which illustrate differences between reference and processed speech samples for a voice conversion application. In this regard, the voicing of original speech 102 is indicated as a dotted line while the voicing of processed speech 104 is indicated as a continuous line. In FIG. 4, a voicing level of 0 represents a situation in which all energy is unvoiced contribution while a voicing level of 1 represents a situation in which all energy is voiced contribution. As can be seen from FIG. 4, actual voicing levels in the original speech 102 and the processed speech 104 can be significantly different. In this example, about 66% of the frames include too much unvoiced contribution (leading to increased levels of noise-like speech content) while about 12% of the frames include too much voiced contribution (or over-voicing). Moreover, as can be seen, relative differences between the original speech 102 and the processed speech 104 fluctuate which leads to instabilities and audible quality degradations in the output. Embodiments of the present invention provide a modification of the processed speech 104 in order to control voicing in the processed speech 104 by providing voicing control in the form of voicing correction to adjust the processed speech 104 to have voicing more similar to that of the original speech 102.

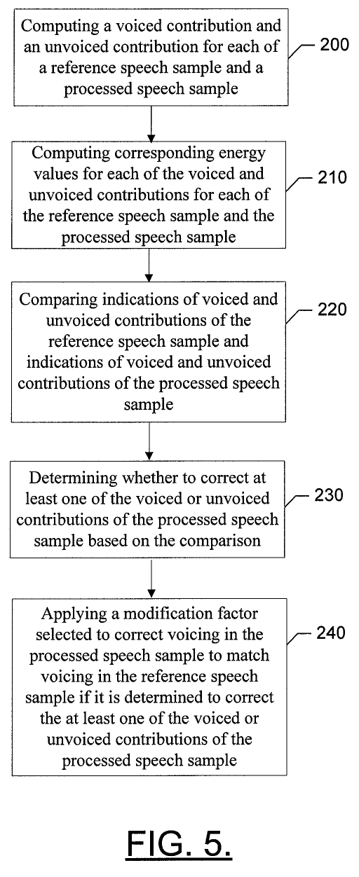

FIG. 5 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method of providing voicing control includes computing a voiced contribution and an unvoiced contribution for each of a reference speech sample and a processed speech sample at operation 200. The method may also include computing corresponding energy values for each of the voiced and unvoiced contributions for each of the reference speech sample and the processed speech sample at operation 210. At operation 220, indications of voiced and unvoiced contributions of the reference speech sample are compared to indications of voiced and unvoiced contributions of the processed speech sample. A determination is made at operation 230 as to whether to correct at least one of the voiced or unvoiced contributions of the processed speech sample based on the comparison. If a determination is made to perform a correction, the method may further include applying a modification factor selected to correct voicing in the processed speech sample to match voicing in the reference speech sample at operation 240. In this regard, however, it should be noted that the desired level of corrected voicing may sometimes differ from the voicing in the reference speech sample. For example, in a voice conversion application, it may be desirable to achieve some kind of change in the voicing (e.g., if the source voice and the target voice have some clear voicing related person-dependent differences). In such a situation, the desired level of voicing would not be the level of voicing in the original signal but some converted version of it. As such, embodiments of the present invention may also be directly applicable in this kind of situation if the voicing correction is performed accordingly. By using voicing correction, the output may be modified to include only desirable changes in voicing (instead of unintentional changes). In other words, the reference speech sample could be a speech sample having a predetermined voicing change inserted therein. Alternatively, the estimated energies of the voiced and unvoiced contributions in the reference speech sample could be adjusted before using them in the voicing correction, or the method for computing the correction factor(s) could be modified, to obtain the desired voicing change.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium. Additionally, it should be noted that although the preceding descriptions refer to modules, it will be understood that such term is used for convenience and thus the modules above need not be modularized, but can be integrated and code can be intermixed in any way desired.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
computing a voiced contribution and an unvoiced contribution for each of a reference speech sample and a processed speech sample;
comparing indications of voiced and unvoiced contributions of the reference speech sample and indications of voiced and unvoiced contributions of the processed speech sample; and
determining whether to correct at least one of the voiced or unvoiced contributions of the processed speech sample based on the comparison.

2. A method according to claim 1, further comprising computing corresponding energy values for each of the voiced and unvoiced contributions for each of the reference speech sample and the processed speech sample.

3. A method according to claim 2, wherein the comparing operation comprises calculating a reference speech voicing ratio and a processed speech voicing ratio and comparing a difference between the reference speech voicing ratio and the processed speech voicing ratio to a threshold.

4. A method according to claim 3, wherein calculating the reference speech voicing ratio comprises calculating a ratio of one of the voiced or unvoiced reference speech contributions to a sum of the voiced and unvoiced reference speech contributions and wherein calculating the processed speech voicing ratio comprises calculating a ratio of one of the voiced or unvoiced processed speech contributions to a sum of the voiced and unvoiced processed speech contributions.

5. A method according to claim 3, further comprising:
correcting the at least one of the voiced or unvoiced contributions of the processed speech sample in response to the difference being above the threshold; and
not correcting the at least one of the voiced or unvoiced contributions of the processed speech sample in response to the difference being below the threshold.

6. A method according to claim 1, further comprising applying a modification factor selected to correct voicing in the processed speech sample to match voicing in the reference speech sample if it is determined to correct the at least one of the voiced or unvoiced contributions of the processed speech sample.

7. A method according to claim 6, wherein applying a modification factor further comprises applying a different modification factor for different frequency bands of the processed speech sample.

8. A method according to claim 6, further comprising converting the processed speech to an original parametric representation.

9. A method according to claim 1, further comprising inserting a predetermined voicing change in the reference speech sample.

10. A method according to claim 1, further comprising one of:
adjusting estimated energies of each of the voiced and unvoiced contributions in the reference speech sample prior to utilizing the reference speech sample in the voicing correction; and
computing a modified correction factor to obtain a desired voicing change.

11. A computer program product comprising at least one computer-readable storage medium having computer-readable program code portions stored therein, the computer-readable program code portions comprising:
a first executable portion for computing a voiced contribution and an unvoiced contribution for each of a reference speech sample and a processed speech sample;
a second executable portion for comparing indications of voiced and unvoiced contributions of the reference speech sample and indications of voiced and unvoiced contributions of the processed speech sample; and
a third executable portion for determining whether to correct at least one of the voiced or unvoiced contributions of the processed speech sample based on the comparison.

12. A computer program product according to claim 11, further comprising a fourth executable portion for computing corresponding energy values for each of the voiced and unvoiced contributions for each of the reference speech sample and the processed speech sample.

13. A computer program product according to claim 12, wherein the second executable portion includes instructions for calculating a reference speech voicing ratio and a processed speech voicing ratio and comparing a difference between the reference speech voicing ratio and the processed speech voicing ratio to a threshold.

14. A computer program product according to claim 13, wherein the second executable portion includes instructions for calculating a ratio of one of the voiced or unvoiced reference speech contributions to a sum of the voiced and unvoiced reference speech contributions and wherein calculating the processed speech voicing ratio comprises calculating a ratio of one of the voiced or unvoiced processed speech contributions to a sum of the voiced and unvoiced processed speech contributions.

15. A computer program product according to claim 13, further comprising:
a fifth executable portion for correcting the at least one of the voiced or unvoiced contributions of the processed speech sample in response to the difference being above the threshold; and
a sixth executable portion for not correcting the at least one of the voiced or unvoiced contributions of the processed speech sample in response to the difference being below the threshold.

16. A computer program product according to claim 11, further comprising a fourth executable portion for applying a modification factor selected to correct voicing in the processed speech sample to match voicing in the reference speech sample if it is determined to correct the at least one of the voiced or unvoiced contributions of the processed speech sample.

17. A computer program product according to claim 16, wherein the fourth executable portion includes instructions for applying a different modification factor for different frequency bands of the processed speech sample.

18. A computer program product according to claim 16, further comprising a fifth executable portion for converting the processed speech to an original parametric representation.

19. A computer program product according to claim 11, further comprising a fourth executable portion for inserting a predetermined voicing change in the reference speech sample.

20. A computer program product according to claim 11, further comprising one of:
a fourth executable portion for adjusting estimated energies of each of the voiced and unvoiced contributions in the reference speech sample prior to utilizing the reference speech sample in the voicing correction; and
a fifth executable portion for computing a modified correction factor to obtain a desired voicing change.

21. An apparatus comprising:
a spectra approximation element configured to compute a voiced contribution and an unvoiced contribution for each of a reference speech sample and a processed speech sample; and
a comparing element configured to compare indications of voiced and unvoiced contributions of the reference speech sample and indications of voiced and unvoiced contributions of the processed speech sample, and to determine whether to correct at least one of the voiced or unvoiced contributions of the processed speech sample based on the comparison.

22. An apparatus according to claim 21, further comprising an energy determination element in communication with the spectra approximation element and the comparing element and configured to compute corresponding energy values for each of the voiced and unvoiced contributions for each of the reference speech sample and the processed speech sample.

23. An apparatus according to claim 22, wherein the comparing element is further configured to calculate a reference speech voicing ratio and a processed speech voicing ratio and compare a difference between the reference speech voicing ratio and the processed speech voicing ratio to a threshold.

24. An apparatus according to claim 23, wherein the comparing element is further configured to calculate a ratio of one of the voiced or unvoiced reference speech contributions to a sum of the voiced and unvoiced reference speech contributions and to calculate the processed speech voicing ratio comprises calculating a ratio of one of the voiced or unvoiced processed speech contributions to a sum of the voiced and unvoiced processed speech contributions.

25. An apparatus according to claim 23, further comprising a correcting element in communication with the comparing element and configured to:
correct the at least one of the voiced or unvoiced contributions of the processed speech sample in response to the difference being above the threshold; and
not correct the at least one of the voiced or unvoiced contributions of the processed speech sample in response to the difference being below the threshold.

26. An apparatus according to claim 21, further comprising a correcting element in communication with the comparing element and configured to apply a modification factor selected to correct voicing in the processed speech sample to match voicing in the reference speech sample if it is determined to correct the at least one of the voiced or unvoiced contributions of the processed speech sample.

27. An apparatus according to claim 26, wherein the correcting element is further configured to apply a different modification factor for different frequency bands of the processed speech sample.

28. An apparatus according to claim 26, wherein the correcting element is further configured to convert the processed speech to an original parametric representation.

29. An apparatus according to claim 26, wherein the apparatus is embodied as a mobile terminal.

30. An apparatus according to claim 21, wherein the reference speech sample includes a predetermined voicing change.

31. An apparatus according to claim 21, further comprising an energy determination element configured to adjust estimated energies of each of the voiced and unvoiced contributions in the reference speech sample prior to utilizing the reference speech sample in the voicing correction, and wherein the comparing element is further configured to compute a modified correction factor to obtain a desired voicing change.

32. An apparatus comprising:
means for computing a voiced contribution and an unvoiced contribution for each of a reference speech sample and a processed speech sample;
means for comparing indications of voiced and unvoiced contributions of the references speech sample and indications of voiced and unvoiced contributions of the processed speech sample; and
means for determining whether to correct at least one of the voiced or unvoiced contributions of the processed speech sample based on the comparison.

33. An apparatus according to claim 32, further comprising means for computing corresponding energy values for each of the voiced and unvoiced contributions for each of the reference speech sample and the processed speech sample.
